(19) United States
(12) Patent Application Publication
(10) Pub. No.: US 2015/0336004 A1
(43) Pub. Date: Nov. 26, 2015

(54) AUTOMATICALLY PROVISIONING GAME OBJECTS TO CHARACTERS IN ONLINE GAMES

(71) Applicant: DeNA Co., Ltd., Tokyo (JP)

(72) Inventors: Yuji SHIMIZU, Tokyo (JP); Nobyshi FUJIMORI, Tokyo (JP); Kazuhiro KONDO, Tokyo (JP)

(73) Assignee: DeNA Co., Ltd., Tokyo (JP)

(21) Appl. No.: 14/284,334

(22) Filed: May 21, 2014

(51) Int. Cl. A63F 13/69

(52) U.S. Cl. CPC A63F 13/69

(57) ABSTRACT

Systems and methods for automatically provisioning game objects, such as gear, to characters in online applications, such as games, are described. In some embodiments, the systems and methods receive an indication that a player of an online game has achieved a task provided by the online game, identify a character assigned to the player, the character being one of multiple characters available to players of the online game, select a game object that is directly associated with the identified character assigned to the player, and automatically provide the player of the online game with the selected game object.

### BACKGROUND

Video games are popular pastime activities. In the past, video games were played on arcade machines, televisions, and computers. More recently, video games are played on portable devices, such as mobile phones and tablets. The video games that are played on portable or mobile devices are sometimes referred to as “mobile video games,” or “online games.” The portable devices (e.g., mobile devices) typically include a touch sensitive display area (e.g., a touchscreen) by which players can view presented video games, provide input to control game actions with the games, navigate options presented by the games, and perform other actions.

Current online games, such as those played using mobile devices, offer a variety of different game environments and accompanying activities to engage current and new players with the games. For example, an online game may enable a player to play a game with friends or other players, may enable a player to compete with friends or other players for rewards and other incentives, and may incentivize the player to introduce the online game to friends of the player that do not play the game. The providers of online games, therefore, constantly implement new games, new game activities, and new game incentives in order to increase the number of people playing their games and engage with the current players of their games.

### SUMMARY

Systems and methods for automatically provisioning game objects, such as gear, to characters in online games and/or other online applications are described. In some embodiments, the systems and methods receive an indication that a player of an online application (e.g., online game, event, and/or other activity or action) has achieved a task provided by the online application, identify a character assigned to the player, the character being one of multiple characters available to players of the online application, select a game object that is directly associated with the identified character assigned to the player, and automatically provide the player of the online application with the selected game object.

In some embodiments, the systems and methods include a player achievement module that receives an indication that a player of an online application has achieved a task provided by the online application, a character identification module that identifies a character assigned to the player, the character being one of multiple characters available to players of the online application, an object selection module that selects a game object that is directly associated with the identified character assigned to the player, and an object provision module that automatically provides the player of the online application with the selected game object.

In some embodiments, the systems and methods determine that a player has reached a level of achievement that is associated with providing the player with a piece of gear to be used during game actions within the online game, identify a current character that is being used by the player when the player reached the level of achievement, and automatically provide the player of the online game with a piece of gear that is associated with the identified current character being used by the player when the player reached the level of achievement.

### BRIEF DESCRIPTION OF THE DRAWINGS

FIG. 1 is a block diagram illustrating a suitable computing environment for provisioning game objects to characters within online applications.

FIG. 2 is a block diagram illustrating the components of a gear fusion system.

FIG. 3 is a flow diagram illustrating a method for automatically provisioning a game object to a character of an online application.

FIG. 4A is a flow diagram illustrating a method for selecting a game object to provision to a character based on a rarity of the game object.

FIG. 4B is a flow diagram illustrating a method for fusing a piece of gear to a character of an online application.

FIGS. 5A-5H are display diagrams illustrating the fusing of gear to characters of an online game.

FIGS. 6A-6B are display diagrams illustrating example interfaces displayed by an online game.

FIG. 7 is a block diagram illustrating a communications system.

FIG. 8 is a block diagram illustrating the components of a server.

FIG. 9 is a block diagram illustrating a user device and/or user system.

### DETAILED DESCRIPTION

Systems and methods for provisioning game objects, such as gear, to characters representing players of online games and/or other applications are described. For example, the systems and methods may include a gear fusion system that receives an indication that a player of an online game has achieved a task provided by the online game, identifies a character assigned to the player, the character being one of multiple characters available to players of the online game, selects a game object (e.g., a piece of gear, such as a weapon, armor, or accessory) that is directly associated with the identified character assigned to the player, and automatically provides the player of the online game with the selected game object (e.g., fuses the piece of gear to other gear assigned to the identified character).

Therefore, the gear fusion system may enable a game provider or other online service provider to realize an engaging and compelling game or activity experience for its players or users by providing the players or users with game objects and other rewards in an easy and efficient manner, which facilitates the players to experience the games or activities using appropriate and optimal accessories, among other things.

### Examples of a Suitable Computing Environment

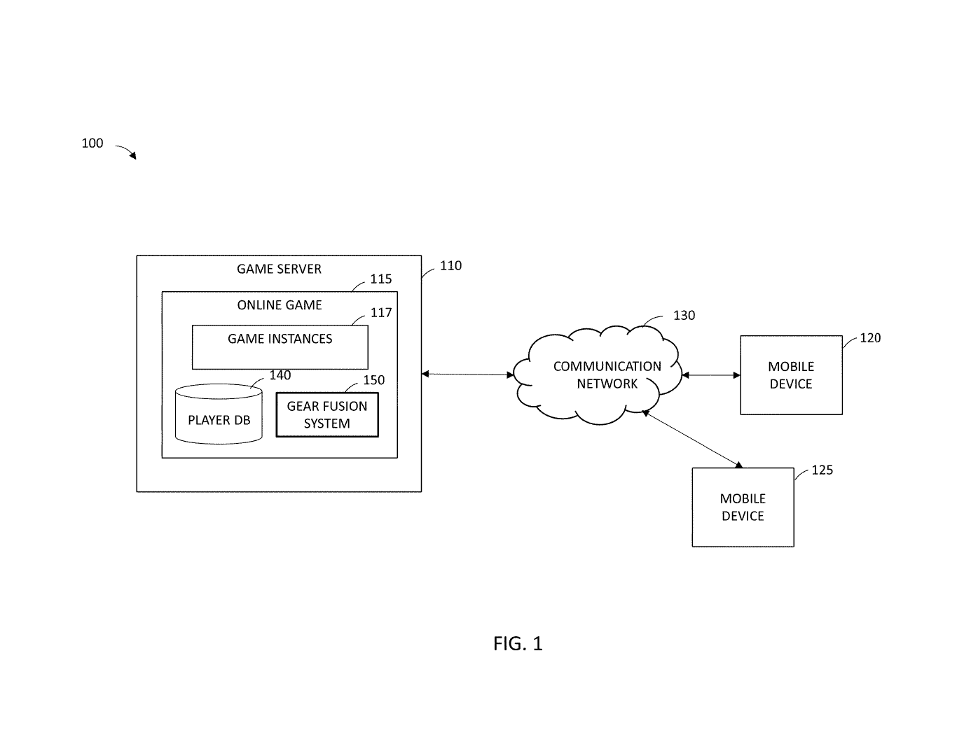

FIG. 1 is a block diagram illustrating a suitable computing environment 100 for provisioning game objects to characters in an online application, such as an online or downloaded (e.g., offline game. The computing environment 100 includes a game server 110 that may support and provide one or more online games 115 to players, such as players at mobile devices 120, 125 that communicate with the game server 110 over a communication network 130 in order to access and provide the online games 115 to the players. For example, players associated with the mobile devices 120, 125 may stream the online games 115 from the game server 110 when playing games, or may download a mobile application (e.g., an “app”) to the mobile devices 120, 125 and play game via the mobile application in an online or offline scenario.

As described herein, in some embodiments, the game server 110 may provide an online game or other online or interactive application to users, such as players. For example, in addition to components configured to provide games, the game server 110 may include components configured to provide and/or support activities, environments, and/or actions to players and other users that include characters to which various game or virtual objects are provisioned as described herein. Example online or app-based applications include online and offline games, social networking or discovery applications and services, interactive learning or information exchange services, online support services, and/or other applications, services, and/or environments within which a user or player is represented by a character.

The communication network 130 may be any network that enables communication between or among servers, machines, databases, and/or devices. Accordingly, the network 130 may be a wide access network (WAN), wired network, a fiber network, a wireless network (e.g., a mobile or cellular network), a cellular or telecommunications network (e.g., WiFi, Global System for Mobile Communications (GSM), Universal Mobile Telecommunications System (UMTS), Long Term Evolution (LTE) network), or any suitable combination thereof. The communication network 130 may include one or more portions of a private network, a public network (e.g., the Internet), or any suitable combination thereof.

The mobile devices 120, 125 may be any type of user device capable of communicating with the game server 110 over the network 130 and presenting the online games 115 to players. Example devices 120, 125 include mobile devices (e.g., laptops, smart phones, tablet computers, and so on), computing devices, set-top boxes, specialized gaming devices, and so on. The mobile devices 120, 125 may support and run various different operating systems, such as Microsoft® Windows®, Mac OS®, Google® Chrome®, Linux®, Unix®, or any other mobile operating system, including Symbian®, Palm®, Windows Mobile®, Google® Android®, Mobile Linux®, and so on.

At any given time, the game server may support, provide, and/or run multiple game instances 117 of an online game 115. A game instance 117 may relate to a single session or game play for one or more players at the mobile devices 120, 125. For example, a game instance 117 may be a single instance or session of the online game 115 that is played via a player at mobile device 120, such as a single game that is played until a player completes all stages of the game and/or reaches an end game status (e.g., a zero lives status) before completing the stages of the game.

The game server 110 includes various databases, such as a player database 140, that store information and data associated with the online games 115, the game instances 117, and the players of the online games 115. For example, the player database 140 may include information identifying the players (e.g., biographical information), information identifying the devices 120, 125 used by the players (e.g., a unique address for the device 120), game play characteristics for the players (e.g., points, levels, or stages achieved within the online games 115, rewards provided to the players, and so on), information identifying the connections between players (e.g., friend lists that identify associations between players), and so on.

In some embodiments, the game server 110 includes a gear fusion system 150 that provides game objects, such as gear, to players of online games based on the characters utilized by the players when playing the games. The gear fusion system 150, therefore, may be included or provided by the online games 115 in order to manage the identification of characters used by players of the online games 115, manage the selection of gear and other game objects to provide to the players, and/or provide the selected gear to the players. Further details regarding the components and methods performed by the gear fusion system 150 are described herein.

### Examples of the Game

The game server 110 may provide a variety of different games and other applications, such as different instances of online games 115 and/or different types of online games 115, such as app-based games (which may or may not be connected to the game server 110 when providing a game instance) and/or games streamed to players via the server 110. For example, the game server 110 may provide progression games, such as games where players progress or move from one stage to another by completing quests, solving puzzles, or performing other tasks. The game server 110 may also provide other games, such as sports games, first person shooter games, massive multiplayer games, strategy games, and so on.

For example, the game server 110 may provide an online game 115 where a player (or players) controls a character and progresses through the game by flying or jumping to higher altitudes within the game environment. In order to progress through the game (e.g., go high or reach a higher altitude) the player may overcome obstacles within the game environment and/or attack and vanquish enemy characters within the game environment.

The player (or players) may select multiple different characters (e.g., three of many available characters) via which the player navigates the game. For example, the player may select tiger, panda, and rabbit as his/her game play characters, from a collection of many different animal character types. The characters may have various inherent or associated game play points or characteristics, such as attack points, hit or health points, jump or movement points, and so on. The player may use one character to play or navigate the game and attempt to reach higher altitudes, or may switch between characters, depending on the obstacles or enemy characters faces within the game environment. The players may collaborate with each other in playing the game as described in the application entitled, “Facilitating the Collaboration of Players in an Online Game,” which is assigned to the same assignee and is filed on the same day as the present application, which is incorporated by reference.

At various stages within the game, such as at certain height levels reached by the player, the online game may reward the player with gear or other virtual game objects which enhance the characteristics of the characters used by the player. For example, upon reaching a first height achievement level, the game may reward the player with a weapon that gives the character enhanced attack points, armor that gives the character enhanced health or hit points, and/or clothing that gives the character enhanced movement or jump points, among other things.

In some embodiments, the provided gear or other virtual game objects may be specific to the characters (e.g., a frog character receives a frying pan as a weapon, whereas a dog character receives a bazooka), and/or may have varying rarity (and, therefore, varying enhancement values). For example, the following is a list of characters that may be available for selection by players of the game, and their associated weapons: (1) Frog and Frying Pan, (2) Ermine (or, Stoat) and Long Bow, (3) Tiger and Talwar, (4) Dog and Bazooka, (5) Rabbit and Sickle, (6) Fox and Crossbow, and (7) Panda and Bo Staff, among others.

Of course, the game server 110 may provide other online games and/or game types to the players at the mobile devices 120, 125.

### Examples of Provisioning Game Objects to Characters

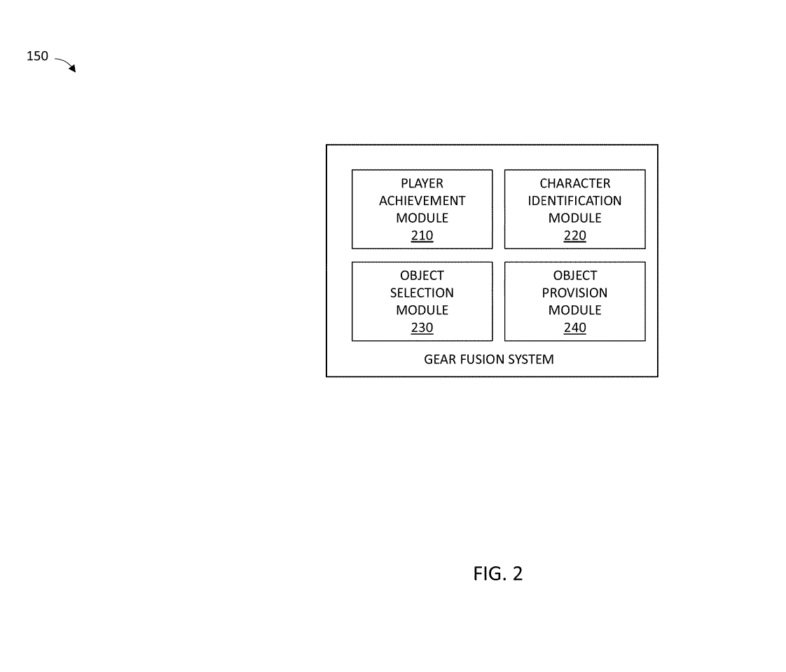

As described herein, in some embodiments, the gear fusion system 150 includes components that facilitate the provisioning of game objects (e.g., weapons, armor, virtual clothing, and so on) to characters of an online game. FIG. 2 is a block diagram illustrating the components of the gear fusion system 150. The gear fusion system 150 may include one or more modules and/or components to perform one or more operations of the gear fusion system 150. The modules may be hardware, software, or a combination of hardware and software, and may be executed by one or more processors. For example, the gear fusion system 150 may include a player achievement module 210, a character identification module 220, an object selection module 230, and an object provision module 240.

In some embodiments, the player achievement module 210 is configured and/or programmed to receive or otherwise access an indication that a player of an online game has achieved a task provided by the online game. For example, the player achievement module 210 may receive an indication that a player has completed a stage or level within a game (e.g., a player has reached a certain altitude within the example game described herein), that the player has completed a task or solved a puzzle or challenged within the game, that the player has earned a certain amount of game currency or points, that the player has purchased the game object, that the player has viewed an advertisement or performed a sponsored action, and so on.

In some embodiments, the character identification module 220 is configured and/or programmed to identify a character assigned to the player, the character being one of multiple characters available to players of the online game. For example, the character identification module 220 may identify one or multiple characters used by the player when playing the online game, such as a character used by the player when the player achieved the task in the game.

In order to identify characters assigned to players, the character identification module 220 may access a table or other data structure, which may be contained in database 140 and/or located at or associated with mobile device 120 or 125, which stores information that relates players to characters and/or assigned game objects. For example, the following data structure may relate players to characters for the game example described herein:

| Player | Assigned Characters |
|---|---|
| Player1 | Dog, Frog |
| Player2 | Tiger, Rabbit, Fox |
| Player3 | Tiger, Frog |

In some embodiments, the object selection module 230 is configured and/or programmed to select a game object that is directly associated with the identified character assigned to the player. The object selection module 230 may select various different game objects, such as gear (e.g., a weapon) used by characters within the game to perform attack game actions, gear (e.g., armor) used by characters to repel attack game actions from other characters within the game, gear (e.g., boots or other accessories) used by characters within the game to enhance the movement game actions, such as jumping actions performed within the game example described herein.

The object selection module 230 may select a game object directly associated with an individual character (e.g., a frying pan is directly associated with a frog in the example game described herein) and/or may select a game object directly associated with a type of character (e.g., the frying pan is directly associated with “jumping” characters).

In order to select a game object directly associated with an individual character, the object selection module 230 may access a table or other data structure, which may be contained in database 140 and/or located at or associated with mobile device 120 or 125, which stores information that relates characters (or, character types) to game objects. For example, the following data structure may characters and/or character types to game objects for the game example described herein:

| Character | Associated Game Objects |
|---|---|
| Frog | Frying Pan, Armor, Boots |
| Jumping Type | Frying Pan, Armor, Boots |
| Fox | Cross Bow, Shield, Pogostick |
| Quick Type | Cross Bow, Shield, Pogostick |

In an embodiment, each gear is directly associated (or assigned) to a single character. For example, Frying Pan is directly associated with Frog and to no other characters so that Frying Pan can only be assigned to Frog. Similarly, Cross Bow is directly associated with Fox and to no other characters so that Cross Bow can only be assigned to Fox.

In another embodiment, each gear is directly associated (or assigned) to a single character type. For example, Frying Pan is directly associated with Jumping Type and to no other character types so that Frying Pan can only be assigned to characters that are Jumping Type. Similarly, Cross Bow is directly associated with Quick Type and to no other character types so that Cross Bow can only be assigned to characters that are Quick Type. In this embodiment, the player may select a plurality of characters, but is allowed to select only a single character from a pool of characters for each character type in order to facilitate automatic gear provisioning and/or fusing by the object provision module 240.

In some embodiments, the object provision module 240 is configured and/or programmed to automatically provide or equip the player of the online game with the selected game object. For example, the object provision module 240 may assign or equip the character used by the player of the online game with a total game play value for an action performed within the online game by adding a game play value assigned to the piece of gear to a game play value of gear associated with the identified character and previously provided to the player of the online game.

In some embodiments, the object provision module 240 fuses gear to characters based on a comparison of the value of the new gear to the value of gear previously earned by a player. For example, the object provision module 240 may identify a game play value for gear currently assigned with the character, determine a total game play value by adding a game play value for the piece of gear associated with the achieved task to the identified game play value for the currently assigned gear with the character, determine that the total game play value is below a threshold value associated with a gear type assigned to the piece of gear, and fuse, combine, or join the piece of gear to the currently assigned piece of gear (or, fuse, combine, or join the game play value of the pieces of gear).

As another example, the object provision module 240 may identify a game play value for gear currently assigned with the character, determine a total game play value by adding a game play value for the piece of gear associated with the achieved task to the identified game play value for the currently assigned gear with the character, determine that the total game play value is above a threshold value associated with a gear type assigned to the piece of gear, fuse the piece of gear to the currently assigned piece of gear based on the determination, and automatically sell the assigned piece of gear to the online game.

In some embodiments, the object provision module 240 fuses gear to characters based on a comparison of the rarity of the new gear to the rarity of gear previously earned by a player. For example, the object provision module 240 may determine a rarity characteristic for the piece of gear, compare the rarity characteristic to a rarity characteristic for gear currently assigned to the character assigned to the player, and fuse the piece of gear to the currently assigned gear based on the comparison.

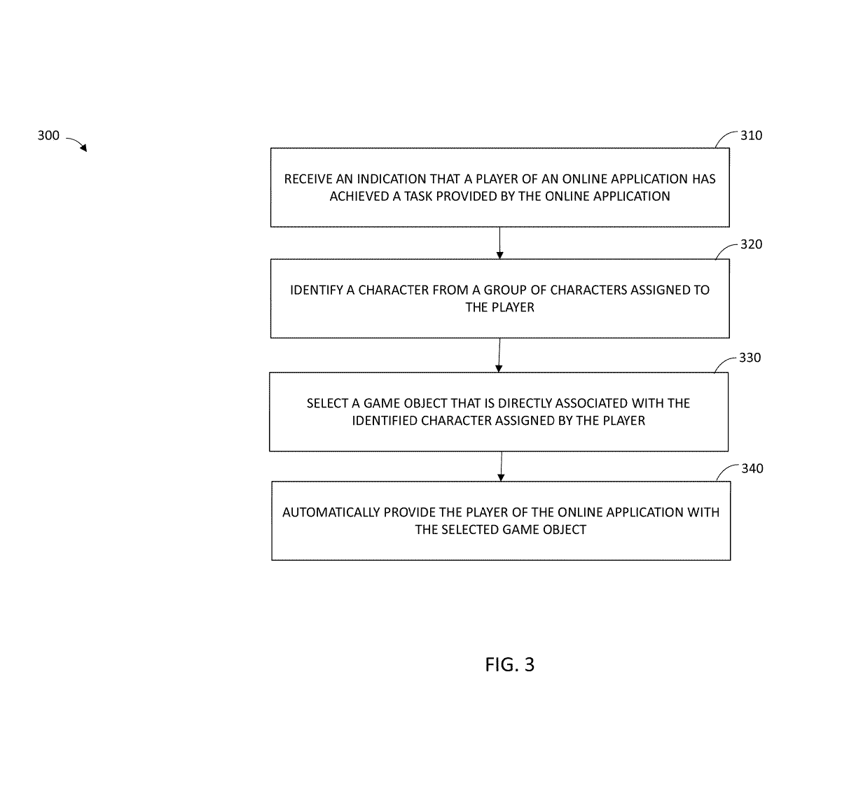

As described herein, the gear fusion system 150 may perform various processes or algorithms when automatically provisioning gear and other game objects to characters associated with players of online games and other applications. FIG. 3 is a flow diagram illustrating a method 300 for automatically provisioning a game object to a character of an online application. The method 300 may be performed by the gear fusion system 150 and, accordingly, is described herein merely by way of reference thereto. It will be appreciated that the method 300 may be performed on any suitable hardware.

In operation 310, the gear fusion system 150 receives an indication that a player of an online application (e.g., online game) has achieved a task provided by the online application. For example, the player achievement module 210 may receive an indication that a player has completed a stage or level within a game (e.g., a player has reached a certain altitude within the example game described herein), that the player has completed a task or solved a puzzle or challenged within the game, that the player has earned a certain amount of game currency or points, that the player has purchased the game object, that the player has viewed an advertisement or performed a sponsored action, and so on.

In operation 320, the gear fusion system 150 identifies a character assigned to the player, the character being one of multiple characters available to players of the online game. For example, the character identification module 220 may identify one or multiple characters used by the player when playing the online application, such as a player used by the player when the player achieved the task in the application.

In operation 330, the gear fusion system 150 selects a game object that is directly associated with the identified character assigned to the player. For example, the object selection module 230 may select various different game objects, such as gear (e.g., a weapon) used by characters within the game to perform attack game actions, gear (e.g., armor) used by characters to repel attack game actions from other characters within the application, gear (e.g., boots or other accessories) used by characters within the application to enhance the movement game actions, such as jumping actions performed within the game example described herein.

The object selection module 230 may select a game object directly associated with an individual character (e.g., a frying pan is directly associated with a frog in the example game described herein) and/or may select a game object directly associated with a type of character (e.g., the frying pan is directly associated with “jumping” characters).

In operation 340, the gear fusion system 150 automatically provides, assigns, and/or equips the player of the online application with the selected game object. The object provision module 240 may assign the character used by the player of the online application with a total game play value for an action performed within the online game by adding a game play value assigned to the piece of gear to a game play value of gear associated with the identified character and previously provided to the player of the online application.

For example, the object provision module 240 may automatically provide the player with a piece of gear that is directly associated with the specific character used by the player when the player achieved the task and/or automatically provide the player with a piece of gear that is directly associated with a character type for the character used by the player when the player achieved the task.

In an embodiment, the object provision module 240 provides a piece of gear to a player when the player achieves a task and selects one of the characters being played by the player based on the direct association between the gear and one of the characters of the player. The gear provided by the object provision module 240 is then automatically assigned or provisioned to the selected character.

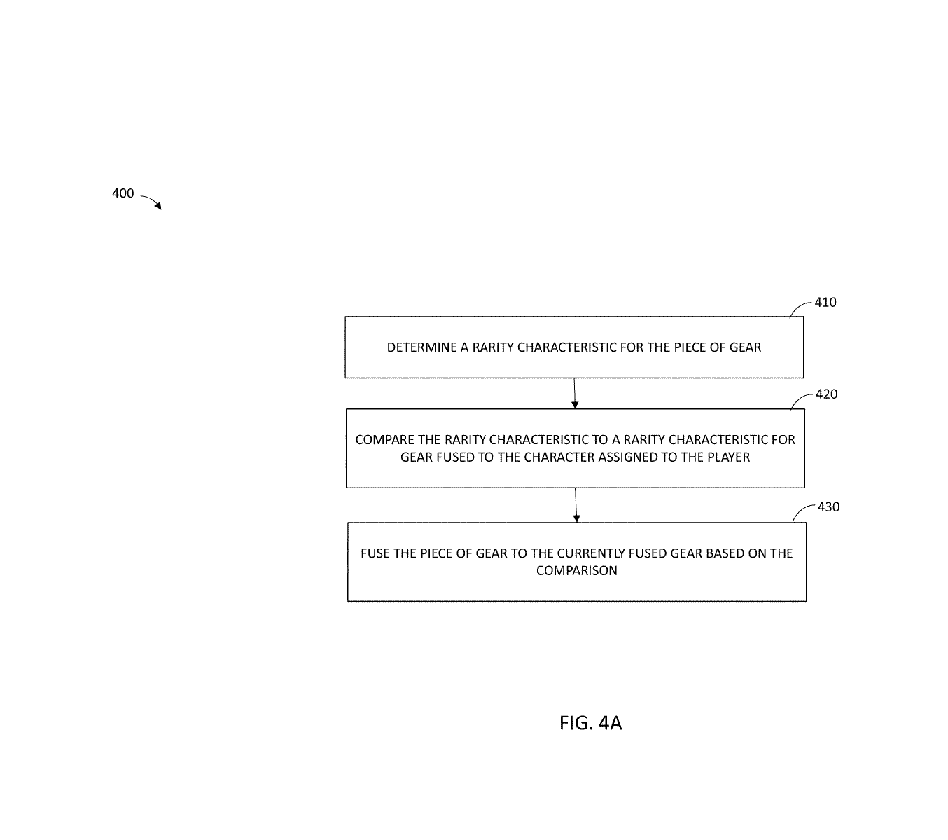

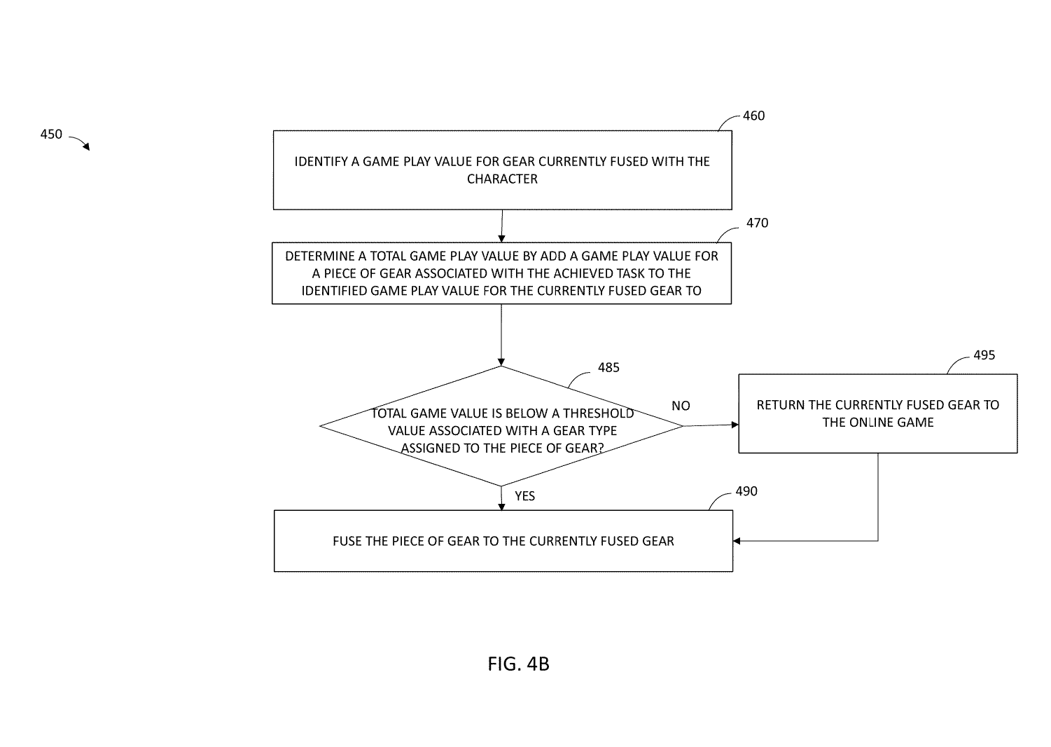

In some embodiments, the object provision module 240 fuses gear to characters based on a comparison of the rarity of the new gear to the rarity of gear previously earned by a player. For example, FIG. 4A depicts a method 400 for selecting a game object to provision to a character based on a rarity of the game object. The method 400 may be performed by the gear fusion system 150 and, accordingly, is described herein merely by way of reference thereto. It will be appreciated that the method 400 may be performed on any suitable hardware.

In operation 410, the gear fusion system 150 determines a rarity characteristic for the piece of gear. For example, the gear fusion system 150 identifies or otherwise determines a rarity value assigned to the piece of gear, such as a value of “common” (e.g., a value assigned to many pieces of gear within the game), a value of “rare” (e.g., a value assigned to a few pieces of gear within the game), a value of “epic” (e.g., a value assigned to one piece of gear), and so on.

In operation 420, the gear fusion system 150 compares the rarity characteristic to a rarity characteristic for gear currently assigned to the character assigned to the player, and in operation 430, fuses the piece of gear to the currently assigned gear based on the comparison. For example, the gear fusion system 150 may determine that the currently assigned gear is “common” gear and the achieved piece of gear is “rare” gear, and fuse the achieved piece of gear to the character because the new piece of gear has a value that is rarer, or less common, than the previously or currently assigned (e.g., previously achieved and assigned) gear.

In some embodiments, the object provision module 240 fuses gear to characters based on a comparison of the value of the new gear to the value of gear previously earned by a player. FIG. 4B depicts a method 450 for fusing a piece of gear to a character of an online game. The method 450 may be performed by the gear fusion system 150 and, accordingly, is described herein merely by way of reference thereto. It will be appreciated that the method 450 may be performed on any suitable hardware.

In operation 460, the gear fusion system 150 identifies a game play value for gear currently fused with the character. For example, the gear fusion system 150 identifies or otherwise determines a game play value for the gear currently assigned to the characters representing the players, such as points or other values associated with the game action strength for the gear.

In operation 470, the gear fusion system 150 determines a total game play value by adding a game play value for the piece of gear associated with the achieved task to the identified game play value for the currently assigned gear with the character.

In operation 480, the gear fusion system 150 determines whether the total game play value is below a threshold value associated with a gear type assigned to the piece of gear. When the total game play value is below the threshold value, the gear fusion system 150, in operation 490, fuses the gear to the currently assigned gear.

When the total game play value is above the threshold value, the gear fusion system 150, in operation 495, fuses the gear to the character and returns the currently or previously assigned gear to the online game. For example, the gear fusion system 150 may sell the currently or previously assigned gear back to the online game and/or to other players within the online game.

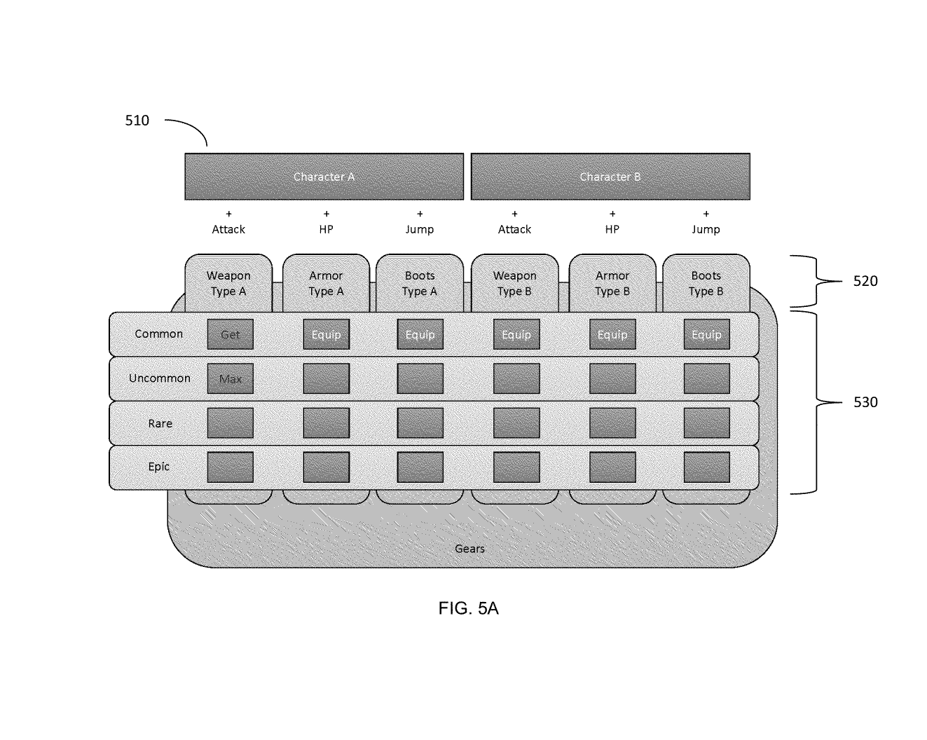

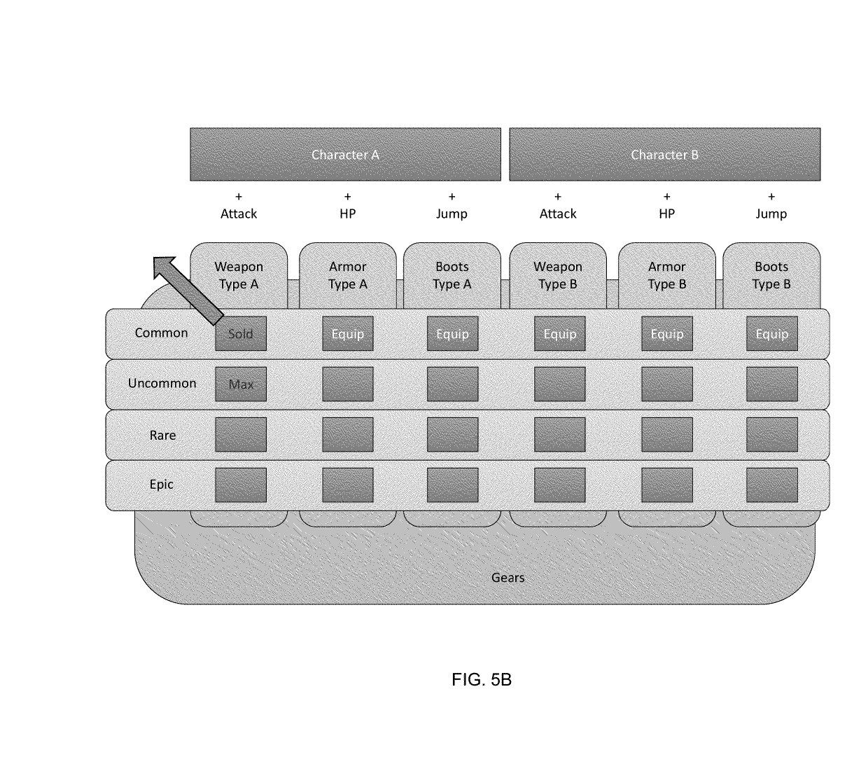

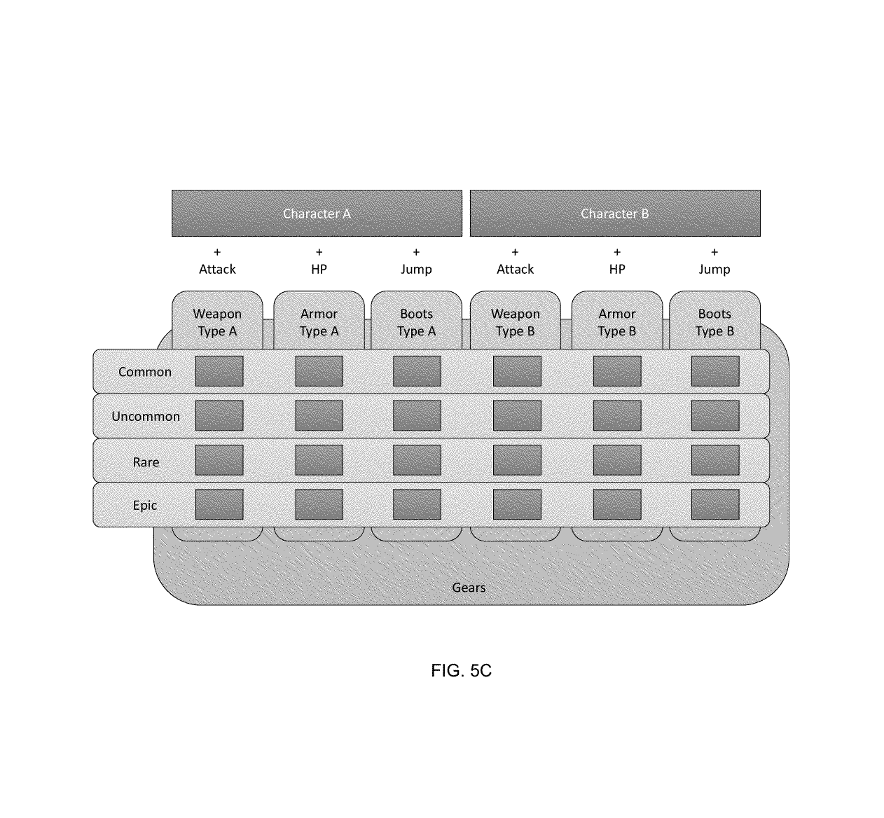

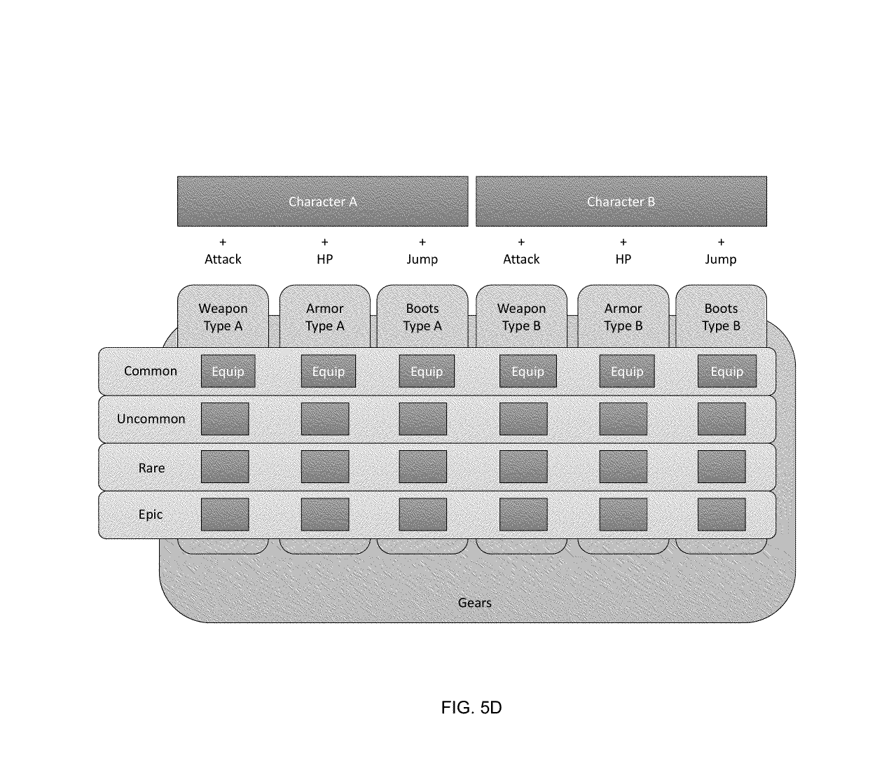

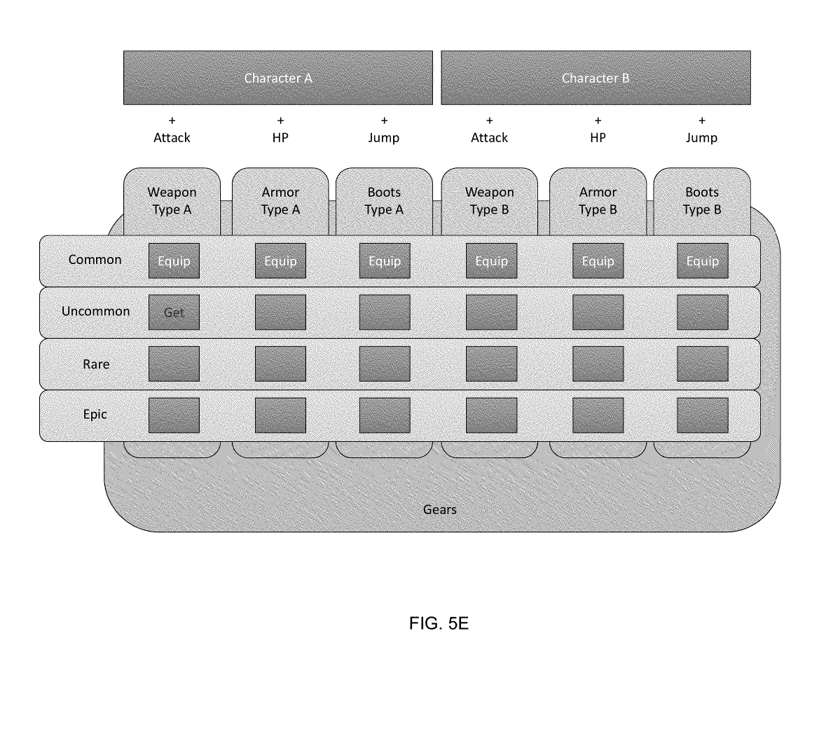

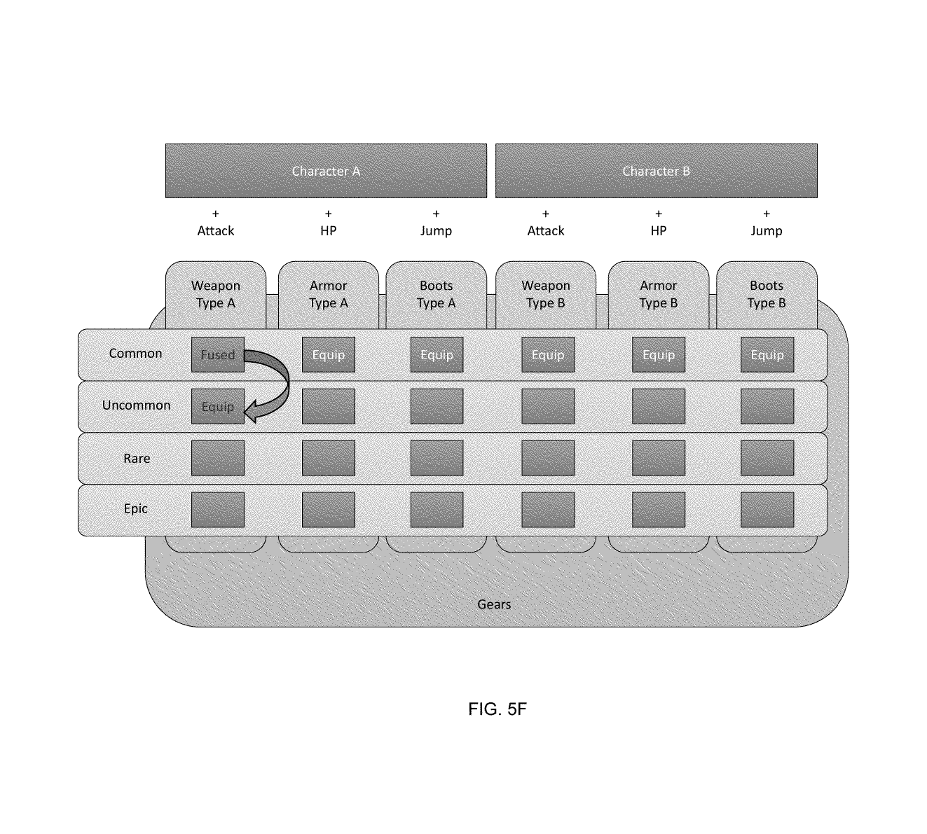

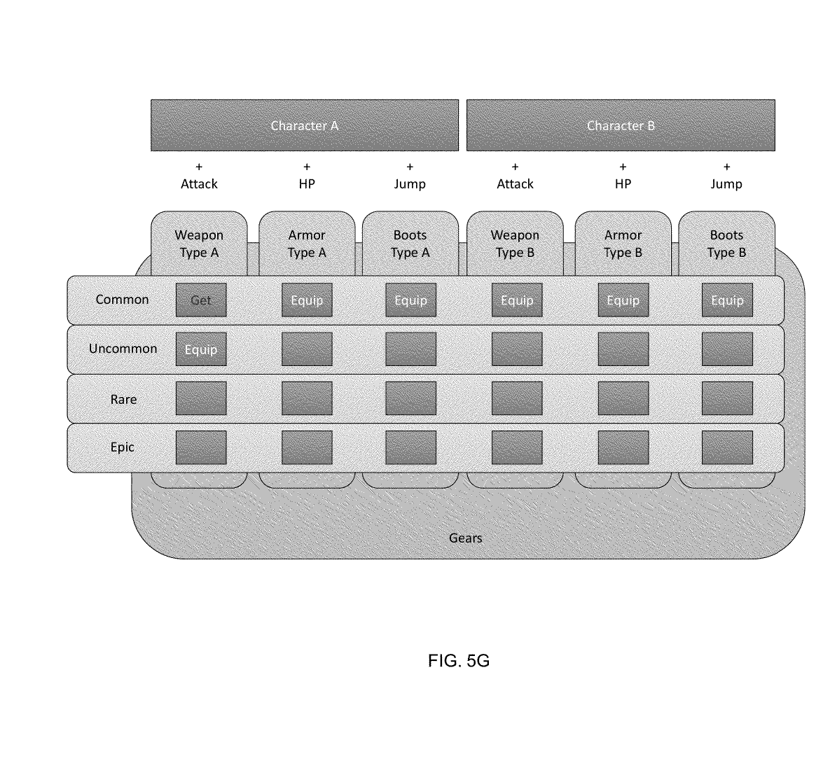

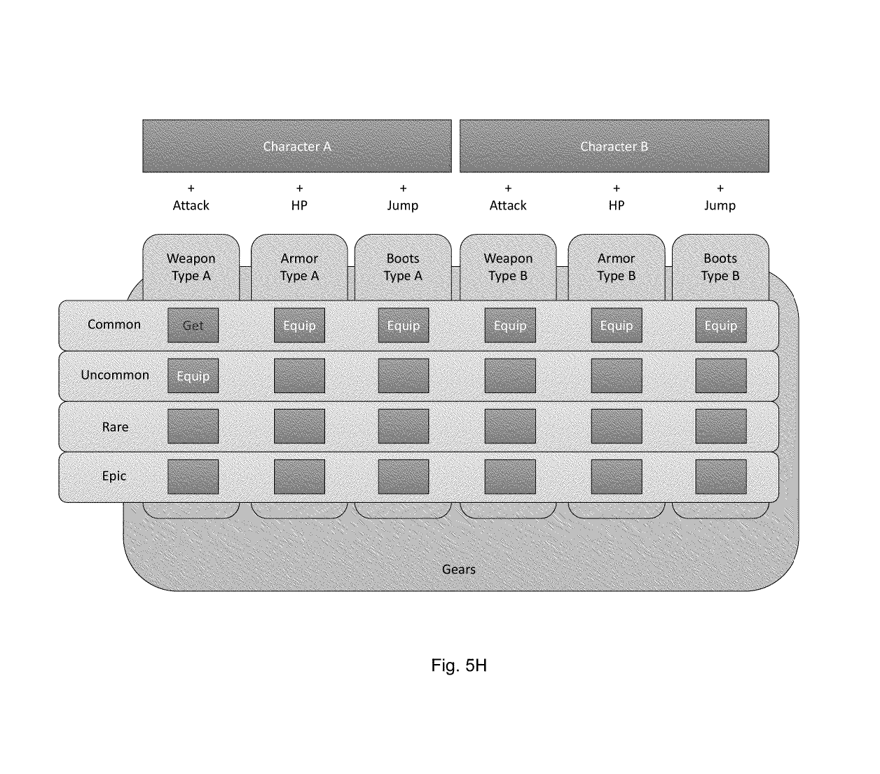

As an example, FIGS. 5A-5H depict the fusing of gear to characters of an online game. FIG. 5A depicts two characters 510 assigned to a player, a character A and a character B, as well as the gear, and gear types 520 (e.g., weapon type A, armor type A, boots type A, weapon type B, armor type B, boots type B), assigned to each of the characters, and the rarity characteristics 530 assigned to the gear.

FIG. 5B depicts “common” gear being currently assigned to the characters. FIG. 5C depicts a piece of “uncommon” gear being rewarded to the player for achieving a task within the game. FIG. 5D depicts the piece of “uncommon” gear being fused with the player based on a comparison of the rarity characteristics of gear, such as via the process of FIG. 4A.

FIG. 5E depicts a piece of “uncommon” gear being rewarded to the player for achieving a task within the game, while “common” gear is currently assigned to the characters, in which case the “common” gear increases a total value of assigned gear to the character, as shown in FIG. 5F.

FIG. 5G depicts an additional piece of “common” gear being rewarded to the player for achieving a task within the game, while the character has already achieved a maximum value for the rarity of gear assigned to the character. FIG. 5H depicts the selling of the “common” gear to the online game when the gear is fused to the character.

For example, following the game example described herein, the gear fusion system 150 may, when the game object is a weapon directly associated with the character, increase the attack points assigned to the character that are associated with attack game actions performed by the character within the online game, when the game object is a piece of armor directly associated with the character, increase the hit points assigned to the character that are associated with absorbing attack game actions from other characters within the online game, and when the game object is a movement accessory directly associated with the character, increase the movement points assigned to the character that are associated with movement game actions performed by the character within the online game.

Therefore, in some embodiments, the gear fusion system 150 may determine that a player has reached a level of achievement that is associated with providing the player with a piece of gear to be used during game actions within the online game, identify a current or previous character used by the player, such as a character used by the player when the player reached the level of achievement, and automatically provide the player of the online game with a piece of gear that is associated with the identified character used by the player, such as a weapon, piece of armor, and/or movement accessory. When providing the gear to the player, the gear fusion system 150 may perform the various processes described herein in order to fuse the gear to other gear assigned to the character used by the player, which enables the gear fusion system 150 to automatically increase the game play value for gear assigned to the player and/or automatically remove or sell off gear assigned to the player that is no longer useful to the player.

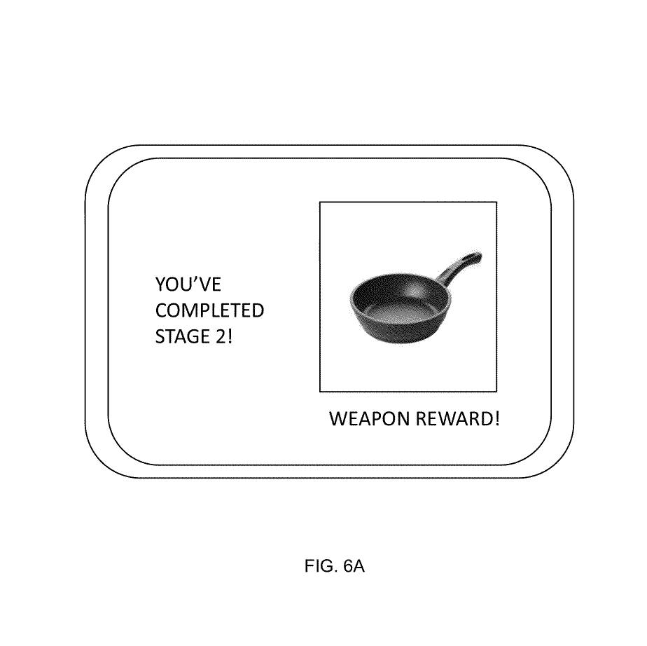

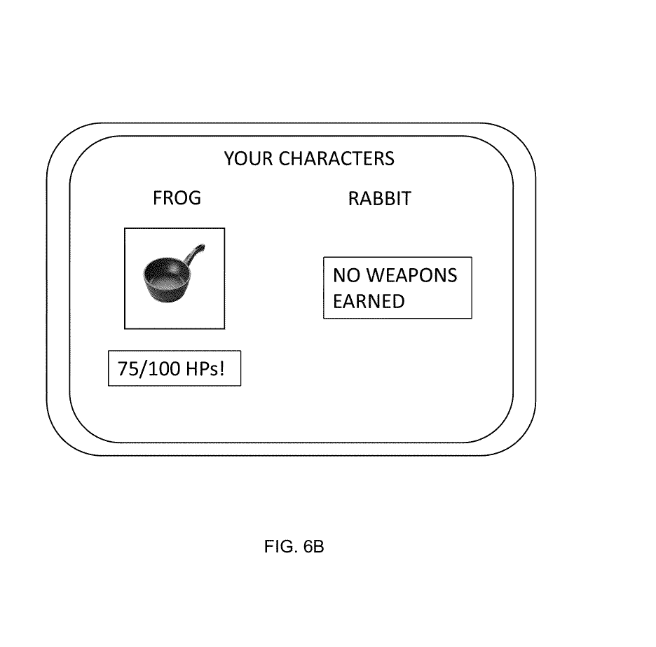

Using the example game described herein, the gear fusion system 150 may facilitate and/or enable the following game play scenario, which is depicted in FIGS. 6A and 6B. A player jumps to an altitude of 150 meters, which is associated with stage 2 of the game. Upon achieving completion of the stage, the game rewards the player with a piece of attack gear. The game, via the gear fusion system 150, identifies the player is using a frog character, and rewards the player with a frying pan weapon, as shown in FIG. 6A. The rewarded frying pan increases the attack points for the frog to 75 (out of a max of 100), as shown in FIG. 6B, which the player may use when fighting enemies within the game. However, when the player uses his other character of a Rabbit, the player will have 0 attack points, because the player has not yet completed a task or achievement which provided a weapon directly associated with the Rabbit character.

Of course, other game play scenarios may implement and/or utilize the gear fusion system 150 and associated methods described herein.

### Examples of Communication and Computing Systems

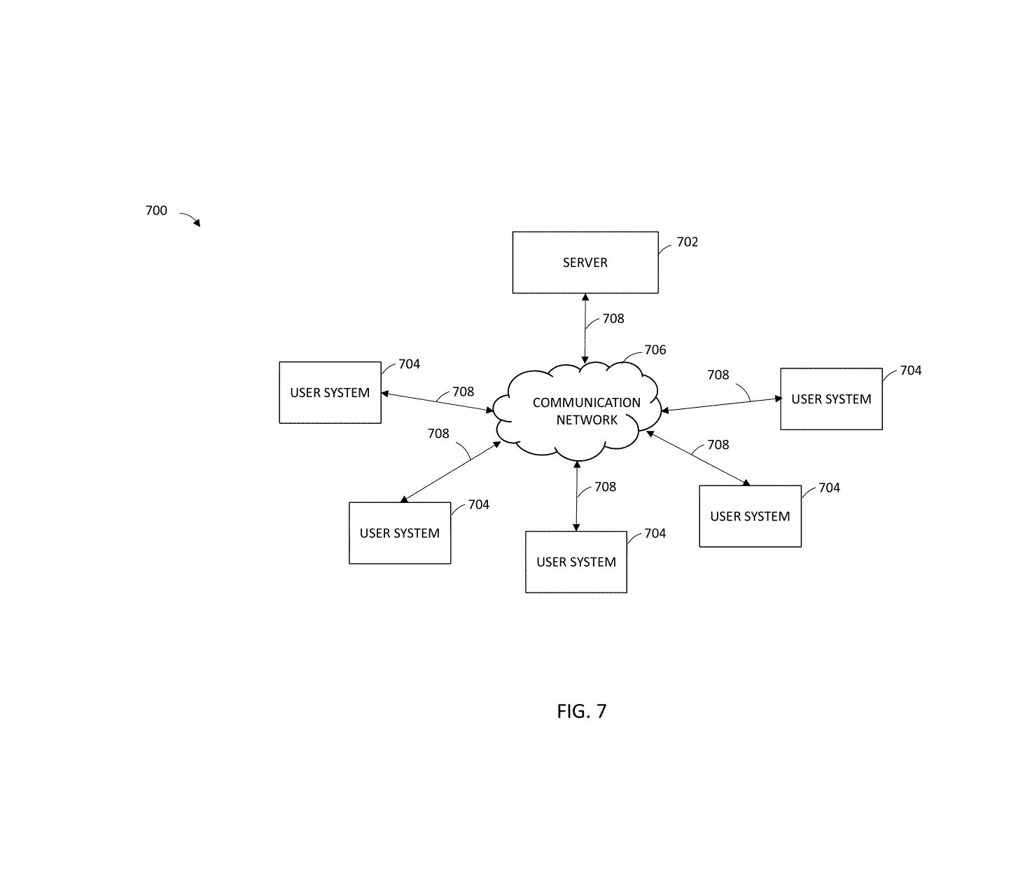

FIG. 7 shows a simplified view of a communications system 1000. The communication system 700 comprises a server 702, which is in communication with a communications network 706 via a communications link 708. A plurality of user systems 704 are in communication with the communications network via links 708, and can download games and other information from the server 702. Server 702 may provide the backend support for playing the video or online games. Server 702 also enables the user systems to download the game, send alerts or messages to the user systems and provide updates to the game.

User systems 704 may be smart phones, tablets, laptops, all-in-one computers, or any other computing device that is suitable for playing video or online games. The user system 704 should have a screen to display the video and an input device to input commands. Both of these functionalities can be provided by a touchscreen. Communication links 708 may be of the wired or wireless variety. Similarly, the communications network itself may comprise wired and/or wireless components.

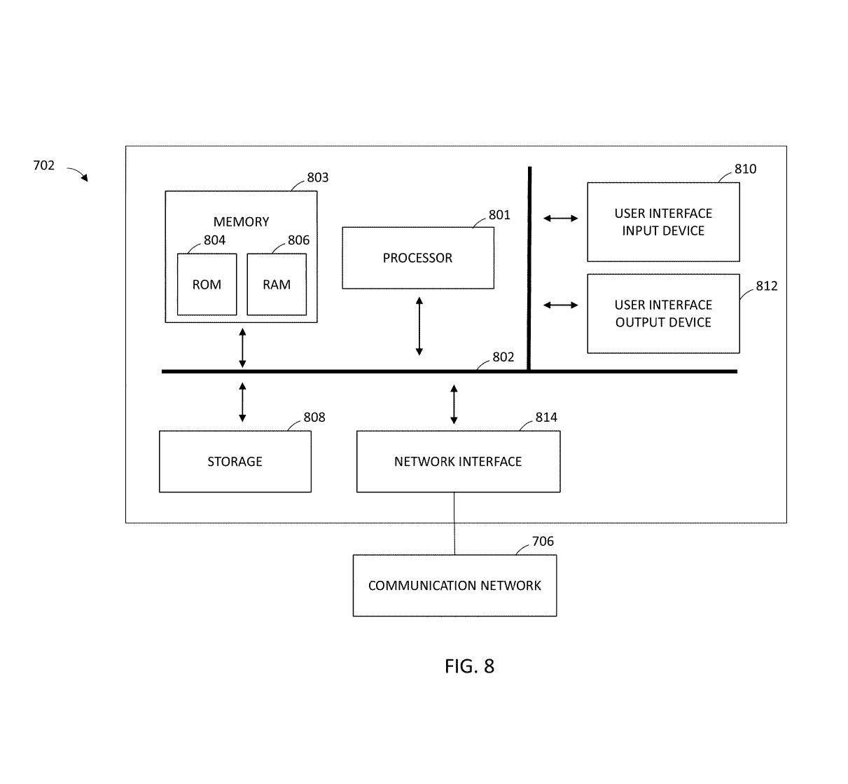

FIG. 8 shows a simplified view of components in server 702 in FIG. 7. Server 702 comprises a processor or CPU 801 that is in communication with a variety of other elements via a bus 802. Such other components of the server include, but are not limited to, a non-transitory computer readable storage medium as a memory 803, including a Read Only Memory (ROM) 804 and a Random Access Memory (RAM) 806, and also a higher capacity non-transitory computer readable storage medium 808. One or more of these elements may be employed by the server to store the computer code representing the instructions for operating the video game. This computer code may be sent from the server over the communication network to a user device, to allow a user to download the video game.

An administrator or other authorized personnel may communicate with the server via a user interface input device 810 (e.g. a keyboard, mouse), for example to update or modify the code being disseminated to the various user devices. The administrator or other authorized personnel may receive information from the server via a user interface output device 812 such as a display screen. This received information may comprise user registrations and/or subscriptions.

Server 702 includes a network interface 814 that is configured to allow information to be communicated between the server and the communications network. An example of such information is the computer code that is executable on the user system to run the video game. Although FIG. 8 illustrates the components of server 702, some of user systems 704 may have the same or similar components thereto.

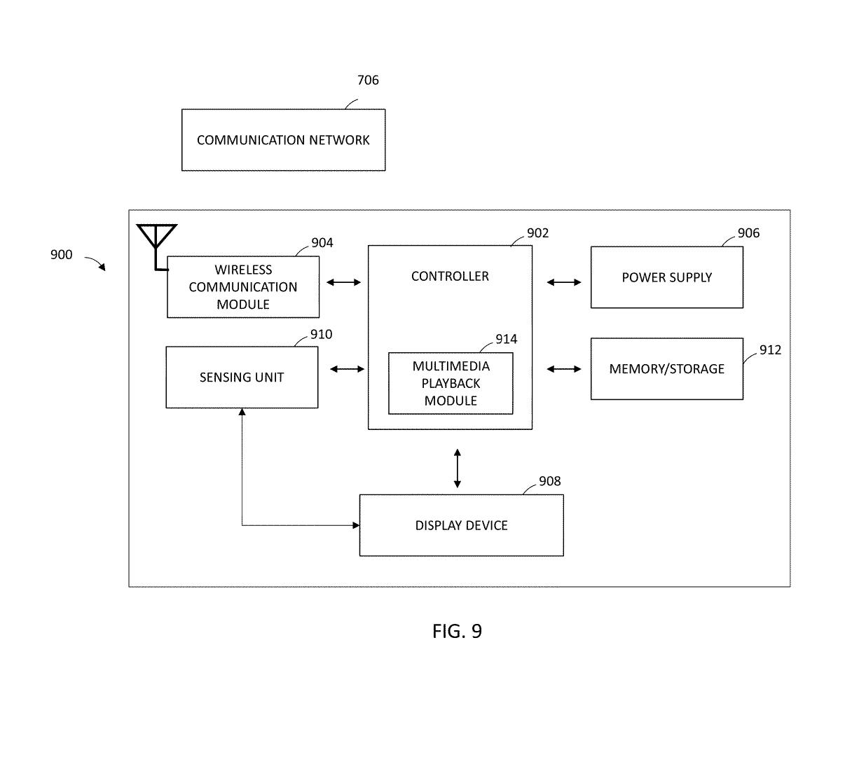

FIG. 9 shows a simplified view of a user device 900 (e.g., mobile device 120 or 125), which is a type of user system 704. User device 900 may be a smart phone or tablet and includes a controller 902 for controlling the operation of the user device, a wireless communication module 904 for communicating with a network, a power supply 906, a display device 908, a sensing unit 910, and a memory/storage unit 912.

Wireless communications module 906 is used to communicate with a wireless network and receive or stream a video game from server 702. The video game or data file received from the server is stored in the memory/storage unit 912 using controller 902. The video game comprises computer code for executing various steps needed to play the video game. In some embodiments, once the game is downloaded to the storage unit, the user device can play the game without being connected to server 702. Alternatively, the game may require user device 900 to remain in communication with server 702 to play the game, or at least receive a key or a portion of the video game each time the user wishes to launch the game.

The video or online game is launched and played using a multimedia playback module 914. The video game is displayed on display device 908 (e.g., a touchscreen) that can also receive inputs from a user. Sensing unit 910 senses inputs made on the touchscreen, including the swiping motions and amounts of downward force exerted thereon. Controller 902 determines a direction and distance based on the input sensed by the sensing unit.

Having thus described embodiments of the present technology, it should be noted by those skilled in the art that the disclosures within are exemplary only, and that various other alternatives, adaptations, and modifications are possible. Accordingly, embodiments are not limited to the specific structures or methods as illustrated and taught herein.

What is claimed is:

1. A method, comprising:
receiving an indication that a player of an online application has achieved a task provided by the online application;
identifying a character assigned to the player, the character being one of multiple characters available to players of the online application;
selecting a game object that is directly associated with the identified character assigned to the player; and
automatically providing the player of the online application with the selected game object.

2. The method of claim 1, wherein the provided game object is a piece of gear that assists the character in playing the online application, and wherein automatically providing the player of the online application with the selected game object includes:
assigning the character used by the player of the online application with a total game play value for an action performed within the online game by adding a game play value assigned to the piece of gear to a game play value of gear associated with the identified character and previously provided to the player of the online application.

3. The method of claim 1, wherein the provided game object is a piece of gear that assists the character in playing the online application, and wherein automatically providing the player of the online application with the selected game object includes:
identifying a game play value for gear currently assigned with the character;
determining a total game play value by adding a game play value for the piece of gear associated with the achieved task to the identified game play value for the currently assigned gear with the character;
determining that the total game play value is below a threshold value associated with a gear type assigned to the piece of gear; and
fusing the piece of gear to the currently assigned piece of gear.

4. The method of claim 1, wherein the provided game object is a piece of gear that assists the character in playing the online application, and wherein automatically providing the player of the online application with the selected game object includes:
identifying a game play value for gear currently assigned with the character;
determining a total game play value by adding a game play value for the piece of gear associated with the achieved task to the identified game play value for the currently assigned gear with the character;
determining that the total game play value is above a threshold value associated with a gear type assigned to the piece of gear;
fusing the piece of gear to the currently assigned piece of gear based on the determination; and
automatically selling the currently assigned piece of gear to the online application.

5. The method of claim 1, wherein the provided game object is a piece of gear that assists the character in playing the online application, and wherein automatically providing the player of the online application with the selected game object includes:
determining a rarity characteristic for the piece of gear;
comparing the rarity characteristic to a rarity characteristic for gear currently assigned to the character assigned to the player; and
fusing the piece of gear to the currently assigned gear based on the comparison.

6. The method of claim 1, wherein selecting a game object that is directly associated with the identified character assigned to the player includes selecting a game object that is directly associated with an individual character available within the online application and currently assigned to the player.

7. The method of claim 1, wherein selecting a game object that is directly associated with the identified character assigned to the player includes selecting a game object that is directly associated with a type of character available within the online application.

8. The method of claim 1, wherein identifying a character assigned to the player includes identifying a character used by the player when the player achieved the task provided by the online application; and
wherein automatically providing the player of the online application with the selected game object includes automatically providing the player with a piece of gear that is directly associated with the specific character used by the player when the player achieved the task.

9. The method of claim 1, wherein identifying a character assigned to the player includes identifying a character used by the player when the player achieved the task provided by the online application; and
wherein automatically providing the player of the online application with the selected game object includes automatically providing the player with a piece of gear that is directly associated with a character type for the character used by the player when the player achieved the task.

10. The method of claim 1, wherein the game object is a weapon directly associated with the character, and wherein automatically providing the player of the online application with the selected game object includes increasing attack points assigned to the character that are associated with attack game actions performed by the character within the online application.

11. The method of claim 1, wherein the game object is a piece of armor directly associated with the character, and wherein automatically providing the player of the online application with the selected game object includes increasing hit points assigned to the character that are associated with absorbing attack game actions from other characters within the online application.

12. The method of claim 1, wherein the game object is a movement accessory directly associated with the character, and wherein automatically providing the player of the online application with the selected game object includes increasing movement points assigned to the character that are associated with movement game actions performed by the character within the online application.

13. The method of claim 1, wherein the online application is an online game.

14. A system, comprising:
a player achievement module that receives an indication that a player of an online game has achieved a task provided by the online game;
a character identification module that identifies a character assigned to the player, the character being one of multiple characters available to players of the online game;
an object selection module that selects a game object that is directly associated with the identified character assigned to the player; and
an object provision module that automatically provides the player of the online game with the selected game object.

15. The system of claim 14, wherein the provided game object is a piece of gear that assists the character in playing the online game, and wherein the object provision module assigns the character used by the player of the online game with a total game play value for an action performed within the online game by adding a game play value assigned to the piece of gear to a game play value of gear associated with the identified character and previously provided to the player of the online game.

16. The system of claim 14, wherein the provided game object is a piece of gear that assists the character in playing the online game, and wherein the object provision module:
identifies a game play value for gear currently assigned with the character;
determines a total game play value by adding a game play value for the piece of gear associated with the achieved task to the identified game play value for the currently assigned gear with the character;
determines that the total game play value is below a threshold value associated with a gear type assigned to the piece of gear; and
fuses the piece of gear to the currently assigned piece of gear.

17. The system of claim 14, wherein the provided game object is a piece of gear that assists the character in playing the online game, and wherein the object provision module:
identifies a game play value for gear currently assigned with the character;
determines a total game play value by adding a game play value for the piece of gear associated with the achieved task to the identified game play value for the currently assigned gear with the character;
determines that the total game play value is above a threshold value associated with a gear type assigned to the piece of gear;
fuses the piece of gear to the currently assigned piece of gear based on the determination; and
automatically sells the currently assigned piece of gear to the online game.

18. The system of claim 14, wherein the provided game object is a piece of gear that assists the character in playing the online game, and wherein the object provision module:
determines a rarity characteristic for the piece of gear;
compares the rarity characteristic to a rarity characteristic for gear currently assigned to the character assigned to the player; and
fuses the piece of gear to the currently assigned gear based on the comparison.

19. The system of claim 14, wherein the object selection module selects a game object that is directly associated with an individual character available within the online game and currently assigned to the player.

20. A computer-readable storage medium whose contents, when executed by an online game, cause the online game to perform operations, the operations comprising:
determining that a player has reached a level of achievement that is associated with providing the player with a piece of gear to be used during game actions within the online game;
identifying a current character that is being used by the player when the player reached the level of achievement; and
automatically providing the player of the online game with a piece of gear that is associated with the identified current character being used by the player when the player reached the level of achievement.

21. The computer-readable storage medium of claim 20, wherein automatically providing the player of the online game with a piece of gear that is associated with the identified current character being used by the player when the player reached the level of achievement includes providing the player with a weapon, piece of armor, or movement accessory.
